(19) United States
(12) Patent Application Publication
(10) Pub. No.: US 2013/0280093 A1
(43) Pub. Date: Oct. 24, 2013

(54) GAS TURBINE ENGINE CORE PROVIDING EXTERIOR AIRFOIL PORTION

(71) Applicants: Mark F. Zelesky, Bolton, CT (US); Tracy A. Propheter-Hinckley, Manchester, CT (US); Dominic J. Mongillo, JR., West Hartford, CT (US); Steven Bruce Gautschl, Naugatuck, CT (US); Mattew A. Devore, Cromwell, CT (US); Benjamin T. Fisk, East Granby, CT (US)

(72) Inventors: Mark F. Zelesky, Bolton, CT (US); Tracy A. Propheter-Hinckley, Manchester, CT (US); Dominic J. Mongillo, JR., West Hartford, CT (US); Steven Bruce Gautschl, Naugatuck, CT (US); Mattew A. Devore, Cromwell, CT (US); Benjamin T. Fisk, East Granby, CT (US)

(21) Appl. No.: 13/454,245

(22) Filed: Apr. 24, 2012

(51) Int. Cl. F01D 5/18; B23P 15/04

(52) U.S. Cl. 416/97 R; 29/889.71

(57) ABSTRACT

A core has a body that includes a cooling passage portion with a film cooling passage portion extending there from to a film cooling hole portion. An exterior airfoil portion is connected to the film cooling hole portion and is spaced apart from the cooling passage portion to provide a space surrounding the film cooling hole portion that corresponds to an exterior airfoil wall.

### BACKGROUND

This disclosure relates to a core for manufacturing an airfoil used in a gas turbine engine. The disclosure also relates to a method of manufacturing the airfoil using the core.

Typically, turbine airfoils are cast using an investment casting process, or lost wax process. A ceramic core is coated and then arranged in a mold and enveloped in wax, which provides a desired airfoil shape. The wax airfoil is subsequently coated in a ceramic slurry that is hardened into a shell. The wax is melted out of the shell, which is then filled with metal to provide the airfoil. The core provides the shape of internal cooling passages within the airfoil. The core may be removed chemically, for example.

In one common manufacturing process, the ceramic core exits the wax airfoil at its trailing edge. The area around this ceramic/wax airfoil interface is typically rough and requires post operations to grind down the excess material. The post operations are typically done by hand and, due to the curved contours of the surfaces of the airfoil, inspection of the final finished surface is difficult to quantify and qualify. As a result, the finally finished metal airfoil often includes undesired positive raised alloy material resulting in local discontinuities on the local external airfoil surface geometry. In this particular instance the positive material is coincident with the aerodynamic throat or gage area at the trailing edge slot location. Typically this area of raised material has been referred to as a “ski jump.” A “ski jump” is a step or a discontinuity in the desired surface contour of the airfoil exterior surface. In order to remove the positive material that results, hand finishing operations are required. If the hand finishing is severe or overly aggressive and deep into the local wall adjacent to the trailing edge coolant ejection location, a thin wall can be formed that will adversely impact the local thermal cooling performance and structural capability of the part. Locally thin walls at the trailing edge slot ejection locations can present subsequent manufacturing challenges associated with collapsing or significantly deforming the locally thin walls due to coating processing requirements. Local positive features or steps can cause disturbances within the boundary layer flow across the external surface of the airfoil, resulting in flow separation increasing aerodynamic losses. Additionally the local positive features or steps can cause local body film and trailing edge slot film cooling to eject into the gas path without properly attaching to the airfoil adversely impacting the local thermal cooling performance.

### SUMMARY

In one exemplary embodiment, a core has a body that includes a cooling passage portion with a film cooling passage portion extending there from to a cooling hole portion. An exterior airfoil portion is connected to the cooling hole portion and is spaced apart from the cooling passage portion to provide a space surrounding the film cooling hole portion that corresponds to an exterior airfoil wall.

In a further embodiment of any of the above, the cooling passage portion, the film cooling passage portion, the cooling hole portion and the exterior airfoil portion provide a unitary body having uniform material properties.

In a further embodiment of any of the above, the unitary body includes a refractory metal.

In a further embodiment of any of the above, the cooling passage portion includes an inner surface, and the exterior airfoil portion includes an outer surface and an exterior core surface spaced apart from one another. The inner and outer surfaces face one another to provide the space.

In a further embodiment of any of the above, the film cooling passage portion includes first and second passage portions joined to one another by a bend.

In a further embodiment of any of the above, the film cooling passage portion includes a diffusion exit.

In a further embodiment of any of the above, the cooling hole portion includes a trough.

In a further embodiment of any of the above, the exterior airfoil portion wraps about an entire perimeter of the core to provide an exterior airfoil surface.

In a further embodiment of any of the above, the exterior airfoil portion includes contoured features that are configured to provide correspondingly-shaped contoured features on an airfoil exterior surface.

In another exemplary embodiment, a method of manufacturing an airfoil comprising the step of providing a core that has a body including a cooling passage portion with a film cooling passage portion extending there from to a film cooling hole portion. An exterior airfoil portion is connected to the cooling hole portion and is spaced apart from the cooling passage portion to provide a space surrounding the film cooling hole portion that corresponds to an exterior airfoil wall.

In a further embodiment of any of the above, the method includes depositing multiple layers of powdered metal onto one another, and joining the layers to one another with reference to CAD data relating to a particular cross-section of the core.

In a further embodiment of any of the above, the method includes coating the core with a metallic coating.

In a further embodiment of any of the above, the method includes enveloping the coated core in wax to provide a wax airfoil with the exterior airfoil portion proud of the wax airfoil.

In a further embodiment of any of the above, the method includes coating the wax airfoil in a ceramic slurry to provide a ceramic airfoil mold, and the ceramic airfoil mold is bonded to the exterior airfoil portion.

In a further embodiment of any of the above, the method includes melting the wax and filling the ceramic airfoil mold to produce an airfoil including leading and trailing edges joined by spaced apart pressure and suction sides that provide an exterior airfoil surface.

In a further embodiment of any of the above, the method includes processing the airfoil to provide desired structural characteristics.

In one exemplary embodiment, a core has a body that includes a cooling passage portion with a film cooling passage portion extending there from to a cooling hole portion. An exterior airfoil portion is connected to the film cooling hole portion and is spaced apart from the cooling passage portion to provide a space surrounding the cooling hole portion that corresponds to an exterior airfoil wall. The cooling passage portion includes an inner surface, and the exterior airfoil portion includes an outer surface and an exterior core surface spaced apart from one another. The inner and outer surfaces face one another to provide the space. The outer surface configured to provide a desired an exterior airfoil surface contour.

In a further embodiment of any of the above, the exterior airfoil portion wraps about an entire perimeter of the core to provide an exterior airfoil surface.

### BRIEF DESCRIPTION OF THE DRAWINGS

The disclosure can be further understood by reference to the following detailed description when considered in connection with the accompanying drawings wherein:

FIG. 1 is a schematic view of a gas turbine engine incorporating the disclosed airfoil.

FIG. 2A is a perspective view of the airfoil having the disclosed cooling passage.

FIG. 2B is a plan view of the airfoil illustrating directional references.

FIG. 3A is a perspective view of an example core.

FIG. 3B is a cross-sectional view of the core shown in FIG. 3A arranged in a wax mold.

FIG. 3C is a cross-sectional view of another example core with an exterior airfoil portion that wraps about the entire perimeter of the core to provide an airfoil exterior surface.

FIG. 4A is an enlarged cross-sectional view of the core shown in FIG. 3A.

FIG. 4B is a perspective view of the core shown in FIG. 4A.

FIG. 4C is a perspective view of an airfoil manufactured using the core shown in FIG. 4B.

FIG. 5A is an enlarged cross-sectional view of another example core.

FIG. 5B is a perspective view of the core shown in FIG. 5A.

FIG. 5C is a perspective view of an airfoil manufactured using the core shown in FIG. 5B.

FIG. 6 is a flow chart depicting an example airfoil manufacturing process.

FIG. 7 is a schematic cross-sectional view of a ceramic-coated core and enveloped in wax, which is coated in a ceramic slurry.

### DETAILED DESCRIPTION

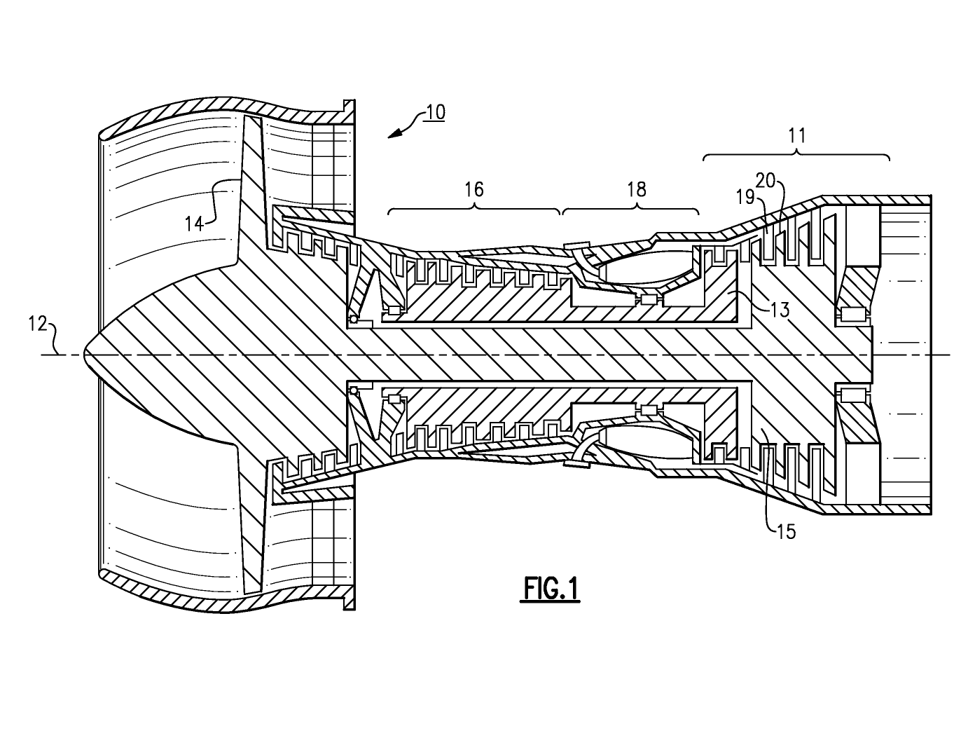

FIG. 1 schematically illustrates a gas turbine engine 10 that includes a fan 14, a compressor section 16, a combustion section 18 and a turbine section 11, which are disposed about a central axis 12. As known in the art, air compressed in the compressor section 16 is mixed with fuel that is burned in combustion section 18 and expanded in the turbine section 11. The turbine section 11 includes, for example, rotors 13 and 15 that, in response to expansion of the burned fuel, rotate, and drive the compressor section 16 and fan 14.

The turbine section 11 includes alternating rows of blades 20 and static airfoils or vanes 19. It should be understood that FIG. 1 is for illustrative purposes only and is in no way intended as a limitation on this disclosure or its application.

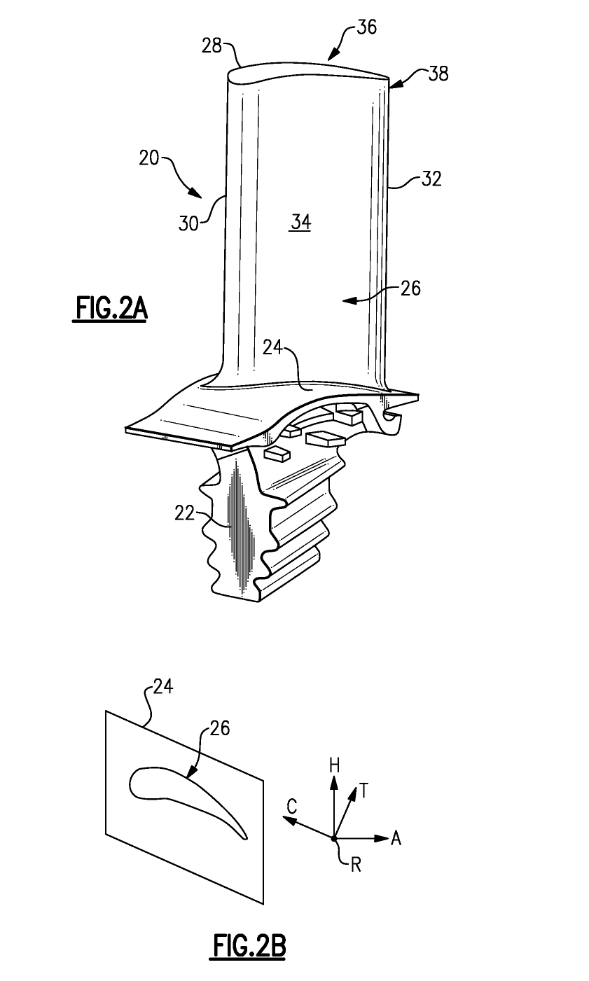

An example blade 20 is shown in FIG. 2A. The blade 20 includes a platform 24 supported by a root 22, which is secured to a rotor, for example. An airfoil 26 extends radially outwardly from the platform 24 opposite the root 22 to a tip 28. While the airfoil 26 is disclosed as being part of a turbine blade 20, it should be understood that the disclosed airfoil may also be used as a vane.

Referring to FIG. 2B, the airfoil 26 includes an exterior airfoil surface 38 extending in a chord-wise direction C from a leading edge 30 to a trailing edge 32. The airfoil 26 is provided between pressure and suction sides 34, 36 in an airfoil thickness direction T, which is generally perpendicular to the chord-wise direction C. Multiple airfoils 26 are arranged circumferentially in a circumferential direction H. The airfoil 26 extends from the platform 24 in a radial direction R to the tip 28. The exterior airfoil surface 38 may include multiple film cooling holes.

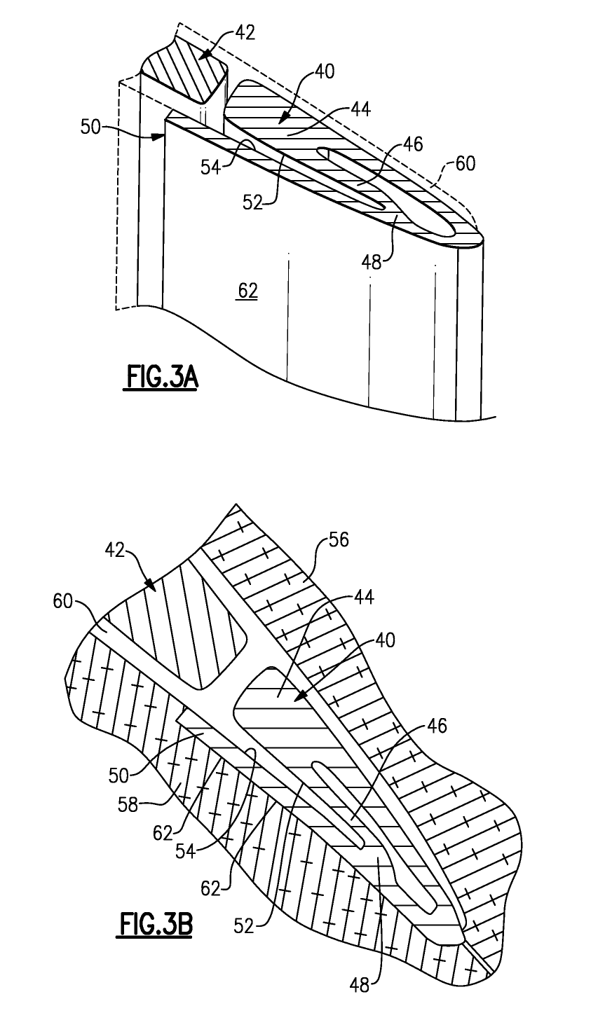

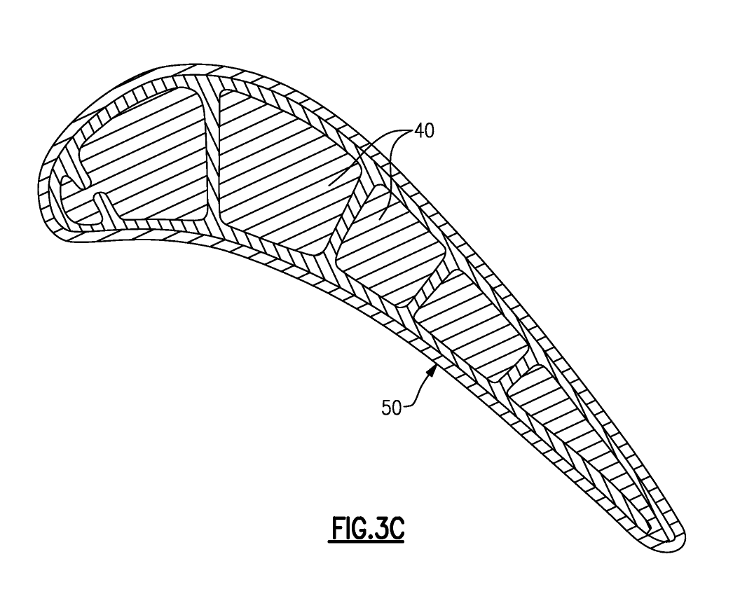

Referring to FIGS. 3A-4C, a core may be provided by first and second cores 40, 42, for example. The core 40 includes a body that has a cooling passage portion 44 with a film cooling passage portion 46 extending there from to a film cooling hole portion 48. The cooling passage portion 44 corresponds to an internal cooling passage 70 within the airfoil 26. The film cooling hole portion 48 corresponds to a film cooling hole 66 provide in the exterior airfoil surface 38.

The film cooling passage portion 46 corresponds to the film cooling passage 68 that feeds cooling fluid from the internal cooling passage 70 to the film cooling hole 66. Film cooling holes provided in this manner may be arranged in close proximity to one another near the trailing edge, for example, or any other desired location. For example, the film cooling holes 66 may be arranged in chord-wise and/or radial rows. Contour features, such as dimples and trenches, may also be provided on the exterior airfoil surface 38 by providing correspondingly shaped features on the outer surface 54 of the exterior airfoil portion 50.

An exterior airfoil portion 50 is integrally connected to the film cooling hole portion 48 and is spaced apart from the cooling passage portion 44 to provide a space surrounding the film cooling hole portion 48 that corresponds to an exterior airfoil wall 64. The cooling passage portion 44 includes an inner surface 52, and the exterior airfoil portion 50 includes an outer surface 54 and an exterior core surface 62 spaced apart from one another. The inner and outer surfaces 52, 54 face one another to provide the space corresponding to the cast wall 64. Fillets and chamfers may be provided where desired.

The cooling passage portion 44, the film cooling passage portion 46, the film cooling hole portion 48 and the exterior airfoil portion 50 provide a unitary body having uniform material properties. The unitary body includes a refractory metal, such as molybdenum, for example. Although the exterior airfoil portion 50 is illustrated as truncated, the exterior airfoil portion could wrap about the entire perimeter of the core thereby defining the entire airfoil exterior surface, as shown in FIG. 3C. The first and second cores 40, 42 are placed into a wax mold having first and second mold portions 56, 58. Wax fills the voids between the first and second cores 40, 42 and the first and second mold portions 56, 58.

The exterior airfoil portion 50 may be used to provide surface contours or features on the airfoil 26, as shown in FIG. 4A-4C. The exterior airfoil portion 50 may include a feature 49, which may protrude or recess relative to the exterior airfoil portion 50, may be used to provide a desired contour or corresponding feature 51 on the exterior airfoil surface 38.

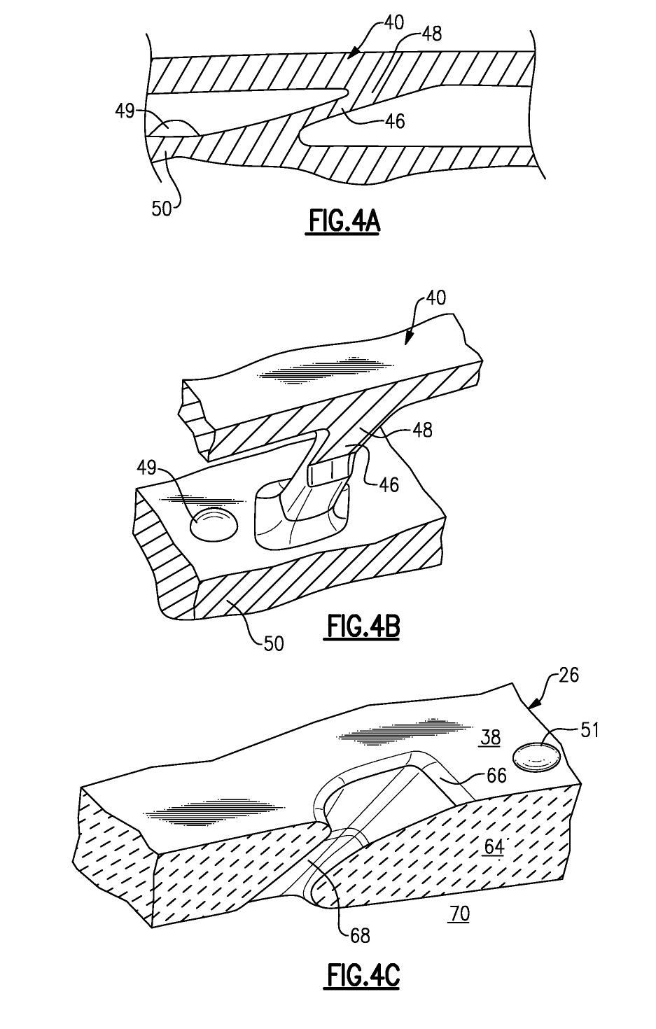

Another example core 140 and resulting airfoil 26 are shown in FIGS. 5A-5C. The film cooling passage portion 146 joins the film cooling hole portion 148 and the exterior airfoil portion 150. In the example, the film cooling hole portion 148 includes first and second passage portions 72, 74 joined to one another by a bend 76. The film cooling passage portion 146 corresponds to the film cooling passage 168 that feeds cooling fluid from the internal cooling passage 170 to the film cooling hole 166. An exterior airfoil portion 150 is integrally connected to the film cooling hole portion 148 and provides a space surrounding the film cooling hole portion 148 that corresponds to an exterior airfoil wall 164.

The film cooling configuration in FIGS. 5A-5C has multiple features which can be used with each other or individually. For example, the bulge into the exterior wall 164 can provide more structural integrity in the area surrounding the film cooling hole 166 which allows for a thinner wall elsewhere and allow the flow in the hole to develop due to its longer length. The film cooling passage 168 undulates to create a tortuous path for the air to flow through so that the speed of the cooling fluid is similar to the speed of the air in the gas path, which makes it more likely that the cooling fluid will attach to the airfoil. This tortuous path also increases the coolant side area relative to a linier hole this improving convective heat transfer. A diffusion exit 73 and a small trough 75 may also be provided to further maintain cooling air attachment. The diffusion exit expands from the interior cooling passage outward toward the exterior airfoil surface 138, which better cools and slows the air down. The trough 75 is a depression that maintains the air in the area for a greater duration to better cool the exterior wall 164.

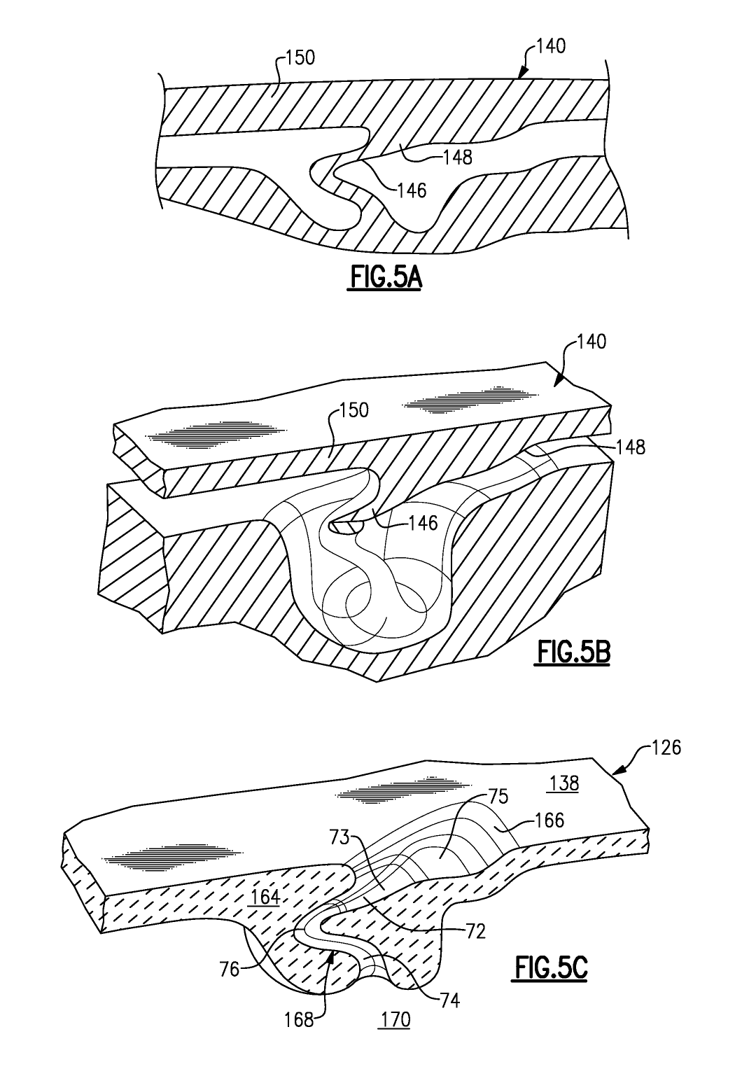

The airfoil geometries disclosed in FIGS. 3A-5C may be difficult to form using conventional casting technologies. Thus, an additive manufacturing process 80 may be used, as schematically illustrated in FIG. 6.

To form the core, powdered metal 82 suitable for refractory metal core applications, such as molybdenum or tungsten, is fed to a machine 84, which may provide a vacuum, for example. The machine 84 deposits multiple layers of powdered metal onto one another. The layers are joined to one another with reference to CAD data 86, which relates to a particular cross-section of the core 40. In one example, the powdered metal 82 may be melted using a direct metal laser sintering process or an electron-beam melting process. With the layers built upon one another and joined to one another cross-section by cross-section, a core with the above-described geometries may be produced, as indicated at 88. A single piece core including both the first and second cores 40, 42 can be produced that requires no assembly and can be directly placed into the wax mold after being coated.

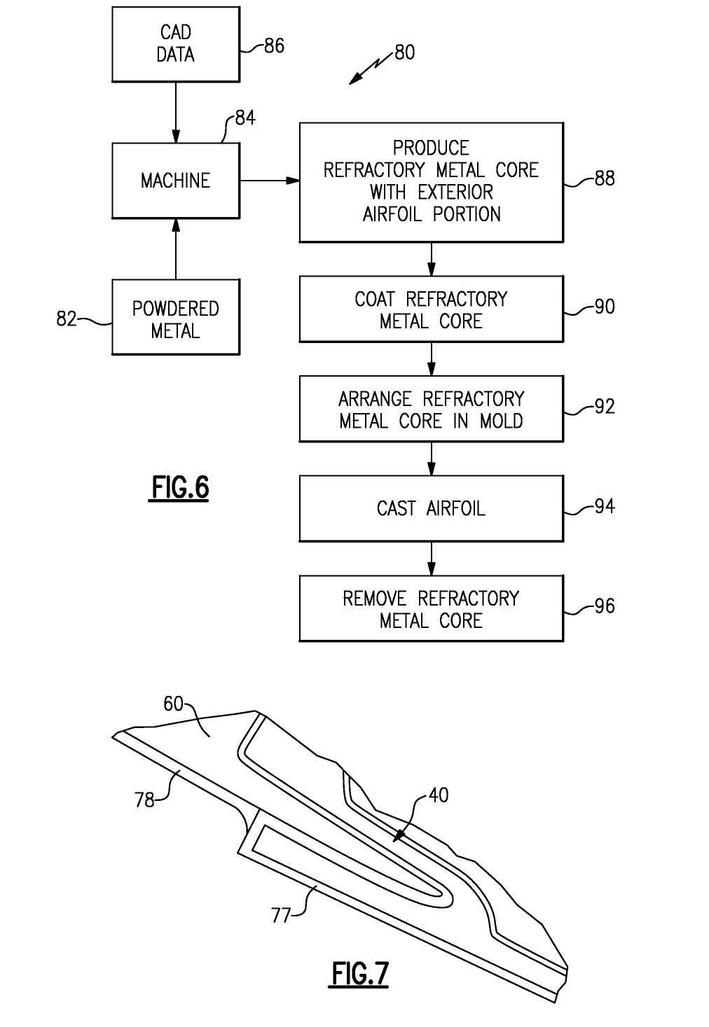

The coating 90 may be applied to the exterior surface of the core 40, which enables the core 40 to be more easily removed subsequently. The core 40 is coated with a metallic coating 77, shown in FIG. 7, which prevents alloying of nickel and molybdenum. The core 40 is arranged in a multi-piece mold and held in a desired orientation by features on the mold, as indicated at 92. The core 40 is more robust and can better withstand handling as it is positioned within the mold.

The core 40 is enveloped in wax to provide a wax airfoil and core assembly with the exterior airfoil portion 50 proud of the wax airfoil 60, for example. The wax airfoil 60 is coated in a ceramic slurry to provide a ceramic airfoil mold 78, as shown in FIG. 7. The ceramic airfoil mold 78 is bonded to the exterior airfoil portion 50. The wax is melted. The airfoil 26 is cast about the core 40, as indicated at 94. The ceramic airfoil mold 78 is filled with a nickel alloy, for example, to provide the airfoil 26. The core 40 is then removed from the airfoil 26, as indicated at 96, to provide desired cooling passage features. Hand finishing of the exterior airfoil surface 38 in the area of the film cooling holes is no longer required.

Although example embodiments have been disclosed, a worker of ordinary skill in this art would recognize that certain modifications would come within the scope of the claims. For that reason, the following claims should be studied to determine their true scope and content.

What is claimed is:

1. A core comprising:
a body including a cooling passage portion having a film cooling passage portion extending there from to a cooling hole portion, an exterior airfoil portion connected to the cooling hole portion and spaced apart from the cooling passage portion providing a space surrounding the film cooling hole portion that corresponds to an exterior airfoil wall.

2. The core according to claim 1, wherein cooling passage portion, the film cooling passage portion, the cooling hole portion and the exterior airfoil portion providing a unitary body having uniform material properties.

3. The core according to claim 2, wherein the unitary body includes a refractory metal.

4. The core according to claim 1, wherein the cooling passage portion includes an inner surface, and the exterior airfoil portion includes an outer surface and an exterior core surface spaced apart from one another, the inner and outer surfaces facing one another to provide the space.

5. The core according to claim 1, wherein the film cooling passage portion includes first and second passage portions joined to one another by a bend.

6. The core according to claim 1, wherein the film cooling passage portion includes a diffusion exit.

7. The core according to claim 1, wherein the cooling hole portion includes a trough.

8. The core according to claim 4, wherein the exterior airfoil portion wraps about an entire perimeter of the core to provide an exterior airfoil surface.

9. The core according to claim 4, wherein the exterior airfoil portion includes contoured features configured to provide correspondingly-shaped contoured features on an airfoil exterior surface.

10. A method of manufacturing an airfoil comprising the steps of:
providing a core including a cooling passage portion having a film cooling passage portion extending there from to a cooling hole portion, an exterior airfoil portion connected to the film cooling hole portion and spaced apart from the cooling passage portion providing a space surrounding the film cooling hole portion that corresponds to an exterior airfoil wall.

11. The method according to claim 10, comprising the steps of depositing multiple layers of powdered metal onto one another, joining the layers to one another with reference to CAD data relating to a particular cross-section of the core.

12. The method according to claim 11, comprising the step of coating the core with a metallic coating.

13. The method according to claim 12, comprising the step of enveloping the coated core in wax to provide a wax airfoil, the exterior airfoil portion proud of the wax airfoil.

14. The method according to claim 13, comprising the step of coating the wax airfoil in a ceramic slurry to provide a ceramic airfoil mold, the ceramic airfoil mold bonded to the exterior airfoil portion.

15. The method according to claim 14, comprising the steps of melting the wax and filling the ceramic airfoil mold to produce an airfoil including leading and trailing edges joined by spaced apart pressure and suction sides that provide an exterior airfoil surface.

16. The method according to claim 15, comprising the step processing the airfoil to provide desired structural characteristics.

17. A core comprising:
a body including a cooling passage portion having a film cooling passage portion extending there from to a cooling hole portion, an exterior airfoil portion connected to the film cooling hole portion and spaced apart from the cooling passage portion providing a space surrounding the cooling hole portion that corresponds to an exterior airfoil wall, the cooling passage portion includes an inner surface, and the exterior airfoil portion includes an outer surface and an exterior core surface spaced apart from one another, the inner and outer surfaces facing one another to provide the space, the outer surface configured to provide a desired an exterior airfoil surface contour.

18. The core according to claim 17, wherein the exterior airfoil portion wraps about an entire perimeter of the core to provide an exterior airfoil surface.
